(19) United States
(12) Patent Application Publication
(10) Pub. No.: US 2019/0238032 A1
(43) Pub. Date: Aug. 1, 2019

(54) MOTOR AND DRIVING DEVICE

(71) Applicant: Nidec Corporation, Kyoto (JP)

(72) Inventors: Kenta MIYOSHI, Kyoto (JP); Satoshi UEDA, Kyoto (JP)

(21) Appl. No.: 16/239,565

(22) Filed: Jan. 4, 2019

(30) Foreign Application Priority Data
Jan. 30, 2018 (JP) 2018-013915

(51) Int. Cl. H02K 11/33; H02K 5/22

(52) U.S. Cl. CPC H02K 11/33; H02K 2203/03; H02K 5/225

(57) ABSTRACT

A motor includes a rotor, a stator, a circuit board, and a motor case. The rotor rotates around a central axis extending vertically. The stator is opposed to the rotor in a radial direction. The circuit board extends in a direction perpendicular to the central axis. In the motor case, the rotor, the stator, and the circuit board are enclosed. The circuit board includes a connector socket and a connector plug. The connector socket is fixed to the circuit board. The connector plug is fixed to a tip end of a lead wire extending outwardly of the motor case, and is connected to the connector socket downward from above the connector socket. A ceiling section of the motor case includes a projection extending downward. A lower end of the projection is opposed in an axial direction to at least a portion of an upper surface of the connector plug.

### CROSS REFERENCE TO RELATED APPLICATIONS

This application claims the benefit of priority to Japanese Patent Application No. 2018-013915 filed on Jan. 30, 2018. The entire contents of this application are hereby incorporated herein by reference.

### BACKGROUND OF THE INVENTION

### 1. Field of the Invention

The present disclosure relates to a motor and a driving device.

### 2. Description of the Related Art

A lead-out structure for a coil device in the related art is known. In a lead-out structure in the related art, a wiring board is connected to a terminal pin connected to a terminal of a coil device. A lead wire is connected to a connector. The connector is connected to the wiring board. Preliminary soldering is not performed on the wire rod of the lead wire. Thus, even when a mechanical load is applied to the lead wire from the outside, it is possible to prevent breakage of the lead wire and to maintain a connection state.

In the lead-out structure for a coil device in the related art, sufficient consideration is not taken for the state of connection between the connector and the wiring board. Thus, there is a problem in that a disconnected state between the connector and the wiring board may occur.

### SUMMARY OF THE INVENTION

An exemplary motor in the present disclosure includes a rotor, a stator, a circuit board, and a motor case. The rotor rotates around a central axis which extends vertically. The stator is opposed to the rotor in a radial direction. The circuit board extends in a direction perpendicular to the central axis. In the motor case, the rotor, the stator, and the circuit board are enclosed. The circuit board includes a connector socket and a connector plug. The connector socket is fixed to the circuit board. The connector plug is fixed to a tip end of a lead wire extending outwardly of the motor case, and is connected to the connector socket downward from above the connector socket. A ceiling section of the motor case includes a projection which extends downward. A lower end of the projection is opposed in an axial direction to at least a portion of an upper surface of the connector plug.

An exemplary driving device in the present disclosure includes the motor in the above-described configuration, and a reducer connected to the motor to reduce a speed of rotations of the rotor and output resultant rotations.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a longitudinal cross-sectional view of a driving device according to an exemplary embodiment of the present disclosure.

FIG. 2 is a perspective view illustrating the longitudinal cross section of a driving device according to an exemplary embodiment of the present disclosure.

FIG. 3 is a longitudinal cross-sectional view of a motor and its surrounding area according to an exemplary embodiment of the present disclosure.

FIG. 4 is a partial perspective view illustrating a connector of the motor and its surrounding area.

FIG. 5 is a partial longitudinal cross-sectional view illustrating the connector of the motor and its surrounding area.

FIG. 6 is a partial longitudinal cross-sectional view illustrating the connector and its surrounding area in a connection incomplete state.

FIG. 7 is an explanatory diagram illustrating a connection process of the connector.

FIG. 8 is a partial front view of a connector of a first modification of an exemplary embodiment of the present disclosure.

FIG. 9 is a partial front view of a connector of a second modification of an exemplary embodiment of the present disclosure.

FIG. 10 is a partial front view of a connector of a third modification of an exemplary embodiment of the present disclosure.

FIG. 11 is a transverse cross-sectional view illustrating an upper portion of the motor.

FIG. 12 is a transverse cross-sectional view illustrating a lower portion of the motor.

### DETAILED DESCRIPTION OF THE PREFERRED EMBODIMENTS

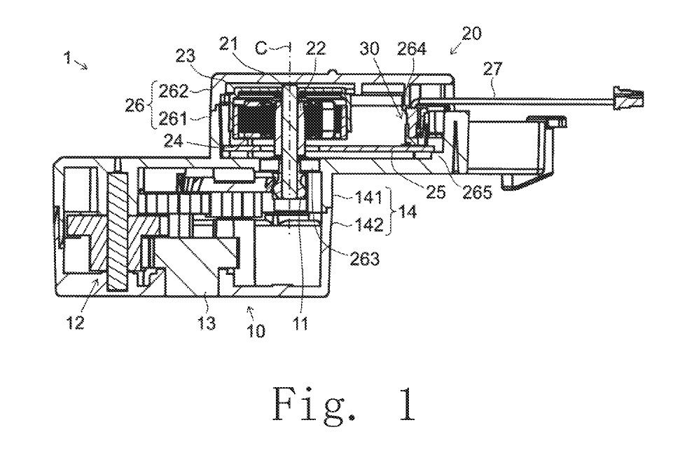

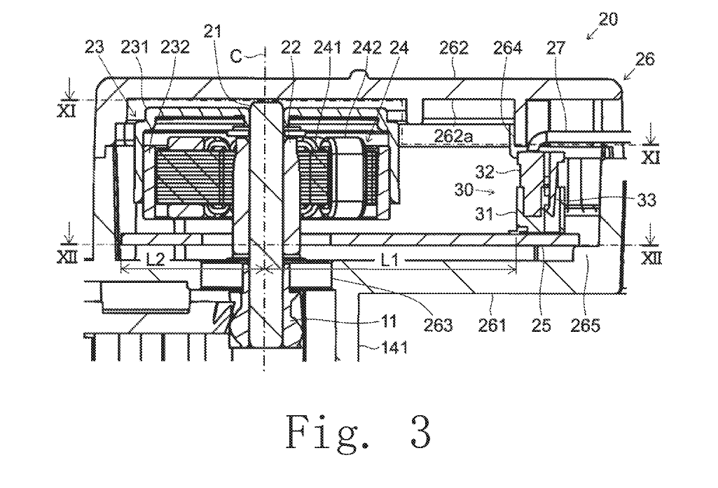

Hereinafter, exemplary embodiments of the present disclosure will be described in detail with reference to the drawings. In the present description, the direction in which the central axis of a motor extends is simply referred to as an “axial direction”, a direction perpendicular to the central axis of the motor as the center is simply referred to as a “radial direction”, and a direction along any arc centered on the central axis of the motor is simply referred to as a “circumferential direction”. In addition, in the present description, for the purpose of illustration, an axial direction is assumed to be the vertical direction, and the geometry of the components and the positional relationship therebetween will be described under the assumption that the vertical direction in FIGS. 1 and 3 is the vertical direction of the motor and the driving device. It is to be noted that the definition of the vertical direction does not limit the direction and the positional relationship when the motor and the driving device are used. In the present description, a cross section parallel to the axial direction is referred to as a “longitudinal cross section”, and a cross section perpendicular to the axial direction is referred to as a “transverse cross section”. Also, “parallel” and “perpendicular” used in the present description do not refer to parallel and perpendicular in a strict sense, and include substantially parallel, and substantially perpendicular.

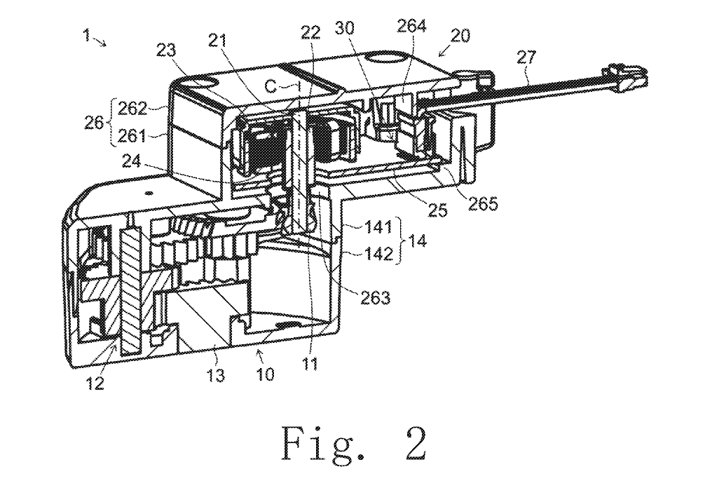

FIG. 1 is a longitudinal cross-sectional view of a driving device 1 according to an embodiment of the present disclosure. FIG. 2 is a perspective view illustrating the longitudinal cross section of the driving device 1 according to the embodiment of the present disclosure. The driving device 1 includes a reduction unit 10, and a motor 20. The reduction unit 10 and the motor 20 are adjacently disposed vertically. That is, the reduction unit 10 is connected to the motor 20.

The reduction unit 10 includes a pinion gear (gear) 11. The reduction unit 10 further includes a speed reduction mechanism 12, a final gear 13, and a gear case 14.

The pinion gear 11 is fixed to a shaft 21 of the motor 20. The pinion gear 11 is disposed at the lower end of the shaft 21. The speed reduction mechanism 12 is connected to the pinion gear 11. The pinion gear 11 is disposed at an input end of a power transmission path of the speed reduction mechanism 12. Rotations of the motor 20 are transmitted to the speed reduction mechanism via the pinion gear 11. The speed reduction mechanism 12 includes a gear group having multiple gears.

The final gear 13 is disposed on the opposite side of the power transmission path of the speed reduction mechanism 12 from the pinion gear 11. In other words, the final gear 13 is disposed at an output end of the power transmission path of the speed reduction mechanism 12. The rotations of the motor 20 transmitted to the speed reduction mechanism 12 are finally transmitted to the final gear 13 via the speed reduction mechanism 12. The speed of rotations of the motor 20 is reduced by the reduction unit 10, and the resultant rotations are outputted from the final gear 13 to the outside. That is, the reduction unit 10 reduces the speed of rotations of the motor 20, and outputs the resultant rotations.

The gear case 14 includes a gear case body 141, and a lower cover 142. The gear case body 141 has a box shape which is open downward. The lower cover 142 covers the opening of the gear case body 141 from below. The gear case 14 includes the pinion gear 11, the speed reduction mechanism 12, and the final gear 13. The gear case 14 rotatably supports the speed reduction mechanism 12 and the final gear 13.

FIG. 3 is a longitudinal cross-sectional view of the motor 20 and its surrounding area according to the embodiment of the present disclosure. The motor 20 includes a rotor 23, a stator 24, a circuit board 25, and a motor case 26. The motor 20 further includes a shaft 21, and a bearing 22.

The shaft 21 is disposed along a central axis C extending vertically. The shaft 21 is a pillar-shaped member that is made of, for instance, metal and extends vertically. The shaft 21 is supported by the bearing 22 such that the shaft 21 is rotatable around the central axis C with respect to the motor case 26.

The rotor 23 is disposed outside the stator 24 in the radial direction. Specifically, the motor 20 is a motor of the outer-rotor type, and is able to achieve high torque. Furthermore, for instance when the motor 20 of the embodiment is connected to the reduction unit 10, it is possible to drive the pinion gear 11 and the speed reduction mechanism 12 with high torque. The rotor 23 is fixed to the shaft 21. The rotor 23 rotates around the central axis C which extends vertically. The rotor 23 includes a rotor yoke 231, and a magnet 232.

The rotor yoke 231 is a substantially cylindrical member having a lid on the top. The rotor yoke 231 is fixed to the shaft 21. In other words, the rotor 23 is fixed to the shaft 21 which is disposed along the central axis C. The magnet 232 has a cylindrical shape, and is fixed to the inner surface of the rotor yoke 231. The magnet 232 is disposed outside the stator 24 in the radial direction. The magnet 232 is opposed to the stator 24 in the radial direction.

The stator 24 is opposed to the rotor 23 in the radial direction. In the embodiment, the stator 24 is disposed inside the rotor 23 in the radial direction. The stator 24 includes a stator core 241, and a coil 242.

The stator core 241 has a ring shape centered on the central axis C. The stator core 241 is formed by stacking, for instance, magnetic steel sheets, such as silicon steel sheets, in the axial direction vertically. The coil 242 is formed of conductive wires wound around the stator core 241 with an insulating material (not illustrated) interposed between the conductive wires and the stator core 241. The stator core 241 and the coil 242 are electrically insulated to each other.

The circuit board 25 is disposed under the stator 24. The circuit board 25 extends in a direction perpendicular to the central axis C. The circuit board 25 is fixed to the motor case 26. The circuit board 25 is electrically connected to a lead wire of the coil 242 (not illustrated). An electronic circuit (not illustrated) for supplying a drive current to the coil 242 is mounted on the circuit board 25. The circuit board 25 may cross the central axis C. Specifically, the circuit board 25 may be substantially perpendicular to the central axis C.

The motor case 26 includes a motor case body 261, and an upper cover 262. The motor case body 261 has a box shape which is open upward. The upper cover 262 covers the opening of the motor case body 261 from the above. The motor case 26 includes the rotor 23, the stator 24, and the circuit board 25. It is to be noted that when the motor case body 261 and the upper cover 262 are fitted together, an area may be formed which communicates with the inside space and the outside space of the motor case 26.

It is to be noted that the motor case body 261 is integrally made of the same component material as that of the gear case body 141 of the reduction unit 10. The gear case body 141 may be made of component material different from that of the motor case body 261, and fixed to the motor case body 261.

The motor case body 261 has a hole 263. The hole 263 disposed in a connection area between the reduction unit 10 and the motor 20. The hole 263 penetrates a wall that separates the reduction unit 10 from the motor 20. The hole 263 communicates with the inside of the motor case 26 and the inside of the gear case 14. The lower portion of the shaft 21 passes through the hole 263, and projects inwardly of the gear case 14. In other words, the shaft 21 projects outwardly of the motor case 26. The pinion gear 11 is fixed to the lower end of the shaft 21.

In the motor 20 in the configuration described above, when a drive current is supplied to the coil 242 via the circuit board 25, a magnetic flux is generated in the stator core 241 in the radial direction. A magnetic field generated by the magnetic flux of the stator 24, and a magnetic field generated by the magnet 232 interact to produce torque in the circumferential direction of the rotor 23. The torque causes the rotor 23 to rotate around the central axis C as the center. The motor 20 outputs the rotational force of the rotor 23 to the reduction unit 10.

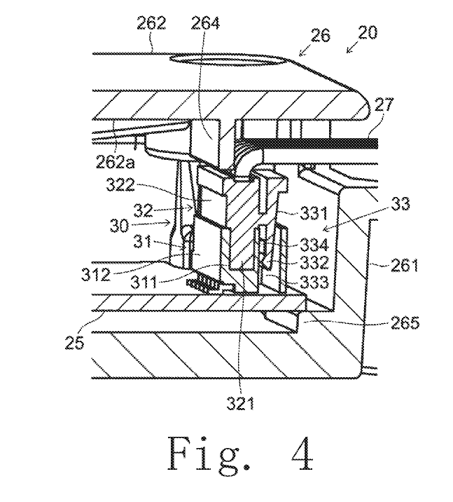

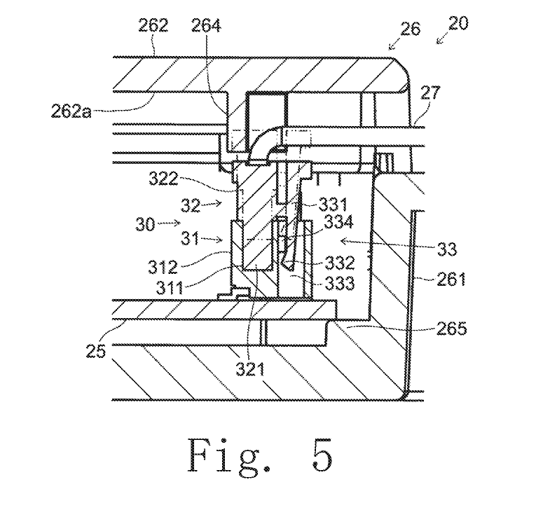

FIG. 4 is a partial perspective view illustrating a connector 30 of the motor 20 and its surrounding area. FIG. 5 is a partial longitudinal cross-sectional view illustrating the connector 30 of the motor 20 and its surrounding area. The circuit board 25 includes connector 30. The connector 30 has a substantially rectangular parallelepiped shape which extends in a direction perpendicular to the radial direction, and in the vertical direction. The connector 30 includes a connector socket 31 and, a connector plug 32. That is, the circuit board 25 includes the connector socket 31, and the connector plug 32. The motor 20 further includes multiple lead wires 27.

The connector socket 31 is fixed to the circuit board 25. The connector socket 31 is disposed on the upper surface of the circuit board 25. The connector socket 31 includes a socket terminal 311. The socket terminal 311 has a recessed shape which is open upward and depressed downward from the upper surface of the connector socket 31. A terminal (not illustrated) to be electrically connected to the connector plug 32 is disposed inside the socket terminal 311. The terminal of the connector socket 31 is electrically connected to a circuit pattern (not illustrated) of the circuit board 25.

The connector plug 32 is fixed to the tip end of each of the lead wires 27. Each lead wire 27 extends outwardly of the motor case 26. In the connector plug 32, the multiple lead wires 27 are arranged in a direction perpendicular to a radial direction in a plane substantially perpendicular to the central axis C. The connector plug 32 includes a plug terminal 321. The plug terminal 321 is disposed on the opposite side of a fixing section of the lead wire 27 in the connector plug 32. A terminal (not illustrated) to be electrically connected to the connector socket is disposed at the tip end of the plug terminal 321. The connector plug 32 is detachably attached to the connector socket 31.

The connector plug 32 is connected to the connector socket 31 downward from above the connector socket 31. In this process, the plug terminal 321 is inserted into the inside of the socket terminal 311. Thus, the terminal of the plug terminal 321 and the terminal of the socket terminal 311 are brought into contact, and are electrically connected to each other.

The upper cover 262 of the motor case 26 includes a projection 264. The projection 264 extends downward from a ceiling section 262a of the upper cover 262. In other words, the ceiling section 262a of the motor case 26 includes the projection 264 which extends downward. The projection 264 has a substantially rectangular parallelepiped shape which extends in a direction perpendicular to the radial direction, and in the vertical direction.

The projection 264 is disposed above the connector 30. The position of the projection 264 in the radial direction is inside, in the radial direction, of a portion the upper surface of the connector plug 32 connected to the lead wire 27. In other words, the lower end of the projection 264 is opposed in the axial direction to at least part of the upper surface of the connector plug 32. In a state where connection between the connector socket 31 and the connector plug 32 is completed, the lower end of the projection 264 is separated from, thus not in contact with the upper surface of the connector plug 32. It is to be noted that in a state where connection between the connector socket 31 and the connector plug 32 is completed, the lower end of the projection 264 may be in contact with the upper surface of the connector plug 32.

According to the configuration of the embodiment described above, when the opening of the motor case body 261 is closed with the upper cover 262, it is possible to push the connector plug 32 downward, in other words, toward the connector socket 31 by the projection 264 of the motor case 26. This enables connection between the connector socket 31 and the connector plug 32. In addition, when the lead wire 27 is pulled, the connector plug 32 is caught by the projection 264. Consequently, it is possible to maintain the state of connection between the connector socket 31 and the connector plug 32.

In FIG. 5, the connector plug 32 is illustrated by a two-dot chain line in a state where the connector socket 31 and the connector plug 32 are disconnected. As illustrated in FIG. 5, the lower end of the projection 264 is located under the upper surface of the connector plug 32 in a state where the connector socket 31 and the connector plug 32 are disconnected. Therefore, in the state where the connector socket 31 and the connector plug 32 are disconnected, when the upper cover 262 is placed on the opening of the motor case body 261, the lower end of the projection 264 comes into contact with the upper surface of the connector plug 32. When the upper cover 262 is fitted into the opening of the motor case body 261, it is possible to push the connector plug 32 downward to the connector socket 31. In a state where the upper cover 262 is fitted into the opening of the motor case body 261, it is possible to complete connection between the connector plug 32 and the connector socket 31.

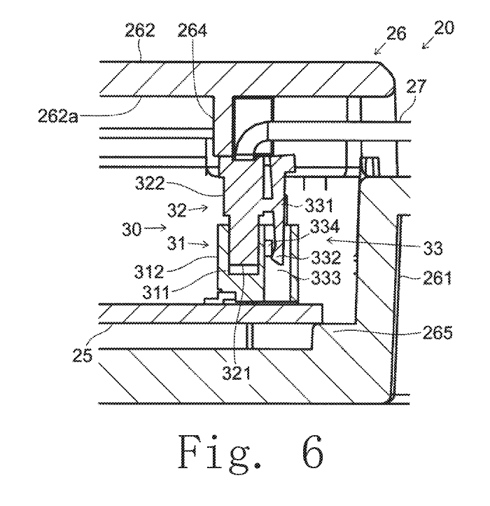

FIG. 6 is a partial longitudinal cross-sectional view illustrating the connector 30 and its surrounding area in a connection incomplete state. FIG. 6 illustrates the state immediately before the upper cover 262 is fitted into the opening of the motor case body 261. In the state of FIG. 6, although the connector 30 is in a connection incomplete state, the connector socket 31 and the connector plug 32 are electrically connected.

The connector 30 includes a connection section 33. The connection section 33 has a snap-fit structure for completing a state of connection between the connector socket 31 and the connector plug 32.

The connection section 33 includes a lever 331, a protruded portion 332, and a recessed portion 333. The connector plug 32 includes the lever 331, and the protruded portion 332. The connector socket 31 includes the recessed portion 333. A structure may be adopted in which the connector socket 31 includes the lever 331 and the protruded portion 332, and the connector plug 32 includes the recessed portion 333.

The lever 331 is disposed on a lateral side of the connector plug 32. The lever 331 has a plate shape which extends in a direction perpendicular to the radial direction, and in the vertical direction. The lever 331 is connected at an approximately center section in the vertical direction with separated from a body 322 of the connector plug 32. It is to be noted that the plug terminal 321 is disposed under the body 322.

The lever 331 is elastically deformed. Specifically, for instance, when the upper portion of the lever 331 is pressed downward so that the upper portion of the lever 331 is brought closer to the body 322 of the connector plug 32, the lever 331 is moved outwardly in the radial direction from a center at a connection point of the body 322, and the lower portion of the lever 331 is separated from the body 322. When a hand pressing the upper portion of the lever 331 is released from the connector plug 32, the lower portion of the lever 331 comes closer to the body 322 by an elastic force of the lever 331.

The protruded portion 332 is provided at the lower end of the lever 331. That is, the protruded portion 332 is provided at the tip end of the lever 331. The protruded portion 332 projects from the lateral side of the lever 331 toward the body 322 of the connector plug 32.

The recessed portion 333 is disposed on the lateral side of the connector socket 31 on the same side as the arrangement region of the lever 331. The recessed portion 333 is disposed at a lower portion of the connector socket 31. A ridge portion 334 is disposed above the recessed portion 333. In other words, the recessed portion 333 is disposed under the ridge portion 334. The ridge portion 334 projects outwardly from the body 312 of the connector socket 31 toward the lever 331. As illustrated in FIG. 5, the recessed portion 333 houses the protruded portion 332 in a state where connection between the connector socket 31 and the connector plug 32 is completed.

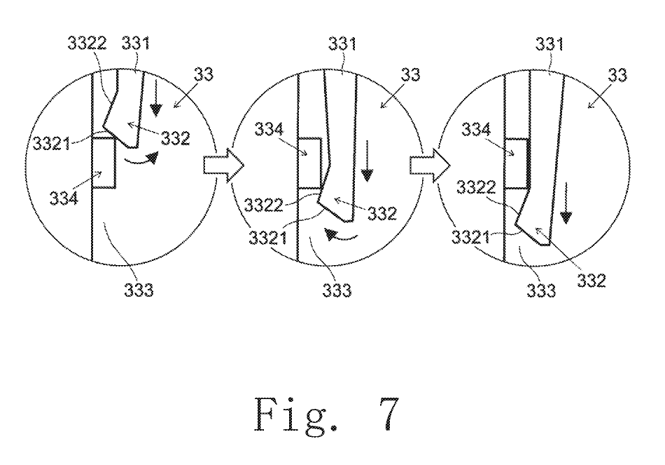

FIG. 7 is an explanatory diagram illustrating a connection process of the connector 30. The view in the middle of FIG. 7 is an enlarged view of the connection section 33 in FIG. 6. The view on the left in FIG. 7 is an enlarged view of the connection section 33 in a state before the state of the connection section 33 in FIG. 6 is achieved.

When the upper cover 262 is fitted into the opening of the motor case body 261, the connector plug 32 is pressed by the projection 264 and moved downward. As illustrated in the view on the left of FIG. 7, in the connection section 33, the protruded portion 332 is brought into contact with the ridge portion 334 from the above.

Specifically, the protruded portion 332 includes a lower inclined face 3321 and an upper inclined face 3322. The lower inclined face 3321 is placed at a lower portion of the protruded portion 332. The lower inclined face 3321 further extends in a direction away from the connector socket 31 at a lower position. The upper inclined face 3322 is placed at an upper portion of the protruded portion 332. The upper inclined face 3322 further extends in a direction toward the connector socket 31 at a lower position.

The ridge portion 334 comes into contact with the lower inclined face 3321, the protruded portion 332 is pressed downward, and thereby moved in a direction away from the connector socket 31. In other words, a lower portion of the lever 331 is moved in a direction away from the connector socket 31 against the elastic force of the lever 331.

When the connector plug 32 is further moved downward, and the protruded portion 332 crosses over the ridge portion 334, the connection section 33 is in the state of the view in the middle of FIG. 7. Subsequently, in the protruded portion 332, the ridge portion 334 comes into contact with the upper inclined face 3322. Thus, a lower portion of the lever 331 is moved in a direction toward the connector socket 31 by the elastic force of the lever 331, and the connector plug 32 itself is moved downward. Consequently, the protruded portion 332 is housed in the recessed portion 333. The connection section 33 is in the state of the view on the right in FIG. 7. The view on the right in FIG. 7 is an enlarged view of the connection section 33 in FIG. 5, and illustrates a state where connection between the connector socket 31 and the connector plug 32 is completed.

In this manner, one of the connector socket 31 and the connector plug 32 includes a lever 331 that is elastically deformed, and the protruded portion 332 provided at the tip end of the lever 331, and the other of the connector socket 31 and the connector plug 32 includes the recessed portion 333 that houses the protruded portion 332 in a state where connection between the connector socket 31 and the connector plug 32 is completed. With this configuration, in the connector 30 having a snap-fit structure, it is possible to complete the state of connection between the connector socket 31 and the connector plug 32. Consequently, it is possible to easily connect the connector socket 31 and the connector plug 32.

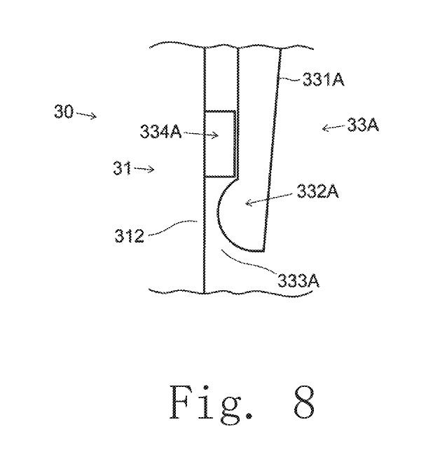

FIG. 8 is a partial front view of the connector 30 of a first modification. The connector 30 of the first modification includes a connection section 33A. The connection section 33A includes a lever 331A, a protruded portion 332A, and a recessed portion 333A. The protruded portion 332A has a semicircle pillar shape which extends in a direction perpendicular to a radial direction. In other words, an area of the protruded portion 332A, which is opposed to the connector socket 31, is a curved face.

When the connector plug 32 is pressed by the projection 264 and moved downward, the ridge portion 334A comes into contact with the lower portion of the curved face, the protruded portion 332A is pressed downward, and thereby moved in a direction away from the connector socket 31. When the connector plug 32 is further moved downward, and the protruded portion 332A crosses over the ridge portion 334A, the ridge portion 334A comes into contact with the upper portion of the curved face of the protruded portion 332A. Thus, a lower portion of the lever 331A is moved in a direction toward the connector socket 31 by the elastic force of the lever 331A, and the connector plug 32 itself is moved downward. Consequently, the protruded portion 332A is housed in the recessed portion 333A, and the connector socket 31 and the connector plug 32 are in the connection-completed state illustrated in FIG. 8.

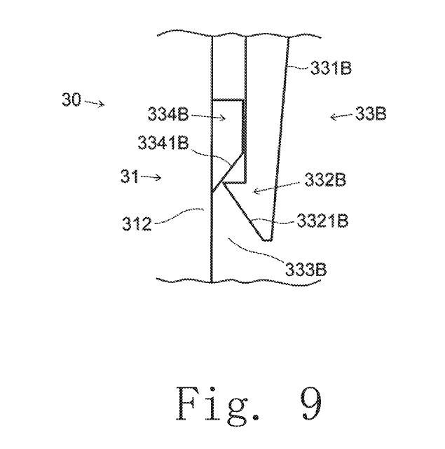

FIG. 9 is a partial front view of the connector 30 of a second modification. The connector 30 of the second modification includes a connection section 33B. The connection section 33B includes a lever 331B, a protruded portion 332B, and a recessed portion 333B. The protruded portion 332B includes an inclined face 3321B that further extends in a direction away from the connector socket 31 at a lower position. A lower portion of a ridge portion 334B includes an inclined face 3341B that further extends in a direction toward the connector socket 31 at a lower position.

When the connector plug 32 is pressed by the projection 264 and moved downward, the ridge portion 334B comes into contact with the inclined face 3321B, the protruded portion 332B is pressed downward, and thereby moved in a direction away from the connector socket 31. When the connector plug 32 is further moved downward, and the protruded portion 332B crosses over the ridge portion 334B, the protruded portion 332B comes into contact with the inclined face 3341B of the ridge portion 334B. Thus, a lower portion of the lever 331B is moved in a direction toward the connector socket 31 by the elastic force of the lever 331B, and the connector plug 32 itself is moved downward. Consequently, the protruded portion 332B is housed in the recessed portion 333B, and the connector socket 31 and the connector plug 32 are in the connection-completed state illustrated in FIG. 9.

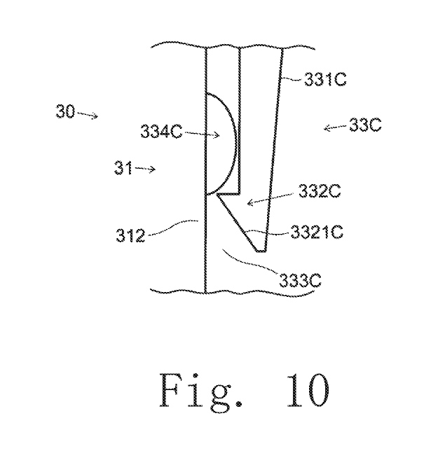

FIG. 10 is a partial front view of the connector 30 of a third modification. The connector 30 of the third modification includes a connection section 33C. The connection section 33C includes a lever 331C, a protruded portion 332C, and a recessed portion 333C. The protruded portion 332C includes an inclined face 3321C that further extends in a direction away from the connector socket 31 at a lower position. A ridge portion 334C has a substantially semicircle pillar shape which extends in a direction perpendicular to a radial direction. In other words, an area of the ridge portion 334C, which is opposed to the protruded portion 332C, is a curved face.

When the connector plug 32 is pressed by the projection 264 and moved downward, the ridge portion 334C comes into contact with the inclined face 3321C, the protruded portion 332C is pressed downward, and thereby moved in a direction away from the connector socket 31. When the connector plug 32 is further moved downward, and the protruded portion 332C crosses over the ridge portion 334C, the protruded portion 332C comes into contact with a lower portion of the curved face of the ridge portion 334C. Thus, a lower portion of the lever 331C is moved in a direction toward the connector socket 31 by the elastic force of the lever 331C, and the connector plug 32 itself is moved downward. Consequently, the protruded portion 332C is housed in the recessed portion 333C, and the connector socket 31 and the connector plug 32 are in the connection-completed state illustrated in FIG. 10.

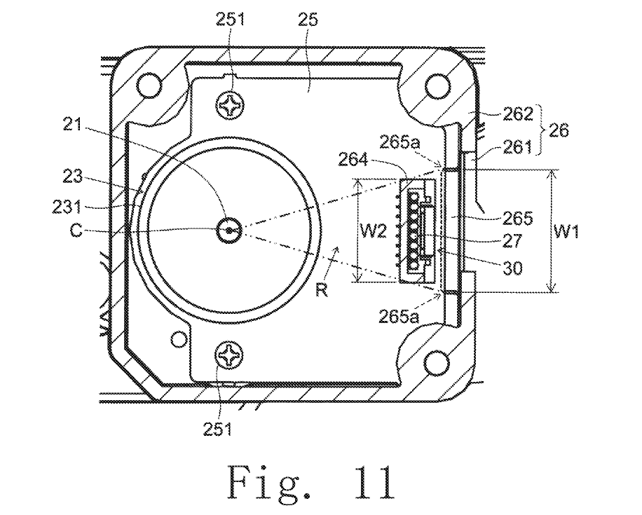

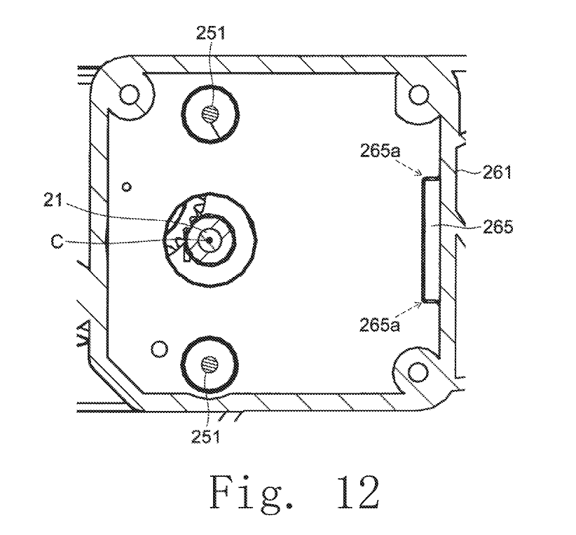

FIG. 11 is a transverse cross-sectional view illustrating an upper portion of the motor 20. It is to be noted that FIG. 11 is a transverse cross-sectional view taken along line XI-XI of the motor 20 illustrated in FIG. 3. FIG. 12 is a transverse cross-sectional view illustrating a lower portion of the motor 20. It is to be noted that FIG. 12 is a transverse cross-sectional view taken along line XII-XII of the motor 20 illustrated in FIG. 3.

The circuit board 25 is fixed to the motor case body 261 with screws 251. The screws 251 are disposed at two positions. The two screws 251 are separated from the central axis C by a predetermined distance in the radial direction, and are disposed at positions substantially symmetric with respect to the central axis C. As illustrated in FIGS. 5 and 6, the circuit board 25 is disposed at a predetermined height from the inner bottom surface of the motor case body 261.

As illustrated in FIGS. 11 and 12, the motor case body 261 includes a seat section 265. Specifically, the inner bottom surface of the motor case 26 includes the seat section 265 that projects upward. The seat section 265 is disposed on the opposite side of the central portion of the circuit board 25 from the positions of the two screws 251. The seat section 265 is disposed adjacent to the side wall of the motor case body 261.

The seat section 265 projects from the inner surface of the side wall of the motor case body 261 toward the central axis C. The seat section 265 has a substantially rectangular parallelepiped shape which extends in a direction perpendicular to a radial direction. The height of the seat section 265 from the inner bottom surface of the motor case body 261 is approximately the height of the lower surface of the circuit board 25 from the inner bottom surface of the motor case body 261. In other words, as illustrated in FIGS. 5 and 6, the lower surface of the circuit board 25 is in contact with the upper surface of the seat section 265. With this configuration, the seat section 265 makes it possible to support the circuit board 25 from the below. Therefore, the arrangement state of the circuit board 25 is stabilized. It is to be noted that the seat section 265 may be disposed with space from the side wall of the motor case body 261 in the radial direction.

The seat section 265 is disposed outside the projection 264 in the radial direction. More particularly, as illustrated in FIG. 11, the seat section 265 is disposed outside the projection 264 with respect to the central axis C in the radial direction. Specifically, the projection 264 is disposed, in a right-left direction of FIG. 11, between two supporting positions for the circuit board 25, the two supporting positions located at both radial ends of the area defined by the screws 251 and the seat section 265. With this configuration, the circuit board 25 is pressed downward by the projection 264 inside, in the right-left direction in FIG. 11, of the positions at which the circuit board 25 is supported by the screws 251 and the seat section 265. Thus, when the connector socket 31 and the connector plug 32 are connected, the circuit board 25 is bent. Therefore, it is possible to prevent damage of the circuit board 25.

In addition, at least part of the projection 264 is disposed inside an area R when viewed in the axial direction, the area R being formed by connecting both ends 265a of the seat section 265 in a circumferential direction and the central axis C. The area R is the area indicated by two-dot chain lines in FIG. 11. Thus, at least part of the projection 264 is disposed inside the area R. With this configuration, a portion in the area R of the circuit board 25 is pressed downward by the projection 264. Consequently, it is possible to reduce excessive bending of a portion of the circuit board 25 inside the area R in a circumferential direction. Therefore, it is possible to allow the circuit board 25 to be bent in an appropriate range.

A length W1 of the seat section 265 in a direction perpendicular to the radial direction is longer than a length W2 of the projection 264 in the direction perpendicular to the radial direction. With this configuration, it is possible to reduce excessive downward bending of the circuit board 25 in a direction perpendicular to the radial direction. Therefore, it is possible to allow the circuit board 25 to be bent in an appropriate range.

As illustrated in FIG. 3, the connector plug 32 is disposed outside the rotor 23 and the stator 24 in the radial direction. The connector plug 32 overlaps with the rotor 23 and the stator 24 in the radial direction. With this configuration, it is possible to reduce interference of the rotor 23 and the stator 24 with connection between the connector socket 31 and the connector plug 32.

The circuit board 25 is disposed under the stator 24. With this configuration, the connector 30 is mounted on the upper surface of the circuit board 25, and the circuit board 25 is disposed under the stator 24. Therefore, it is possible to reduce the length of the entire motor 20 in the axial direction.

A radial distance L1 between the central axis C and the connector socket 31 is longer than a radial distance L2 between the outer edge of the circuit board 25 and the central axis C in a direction symmetric to the radial direction with respect to the central axis C. With this configuration, the rotor 23 and the stator 24 are eccentrically located on one side of the central portion of the circuit board 25. Thus, it is possible to increase the region of a side on which the connector socket 31 is disposed as much as possible compared with a certain area of the circuit board 25, the side being relative to the central axis C. Thus, it is possible to reduce the circuit board 25 to a necessary minimum size. That is, it is possible to miniaturize the entire motor 20.

In addition, the driving device 1 in the configuration described above includes the reduction unit 10, and the motor 20. The reduction unit 10 is connected to the motor 20, and reduces the speed of rotations of the motor 20, and outputs the resultant rotations. With this configuration, it is possible to achieve connection between the connector socket 31 and the connector plug 32 in the driving device 1. In addition, it is possible to maintain the connection between the connector socket 31 and the connector plug 32 in the driving device 1.

In the driving device 1, the motor 20 includes the shaft 21 to which the rotor 23 is fixed and which is disposed along the central axis C, and projects outwardly of the motor case 26. The reduction unit 10 includes a gear fixed to the shaft 21. In the embodiment, the gear fixed to the shaft 21 is the pinion gear 11. With this configuration, it is possible to rotate the pinion gear 11 by the motor 20. In particular, in the case of the motor 20 of the outer-rotor type, it is possible to achieve rotation of the pinion gear 11 with high torque.

The present disclosure is applicable to a motor and a driving device, for instance.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor that rotates around a central axis which extends vertically;
a stator that is opposed to the rotor in a radial direction;
a circuit board that extends in a direction perpendicular to the central axis; and
a motor case in which the rotor, the stator, and the circuit board are enclosed; wherein
the circuit board includes:
a connector socket fixed to the circuit board; and
a connector plug that is fixed to a tip end of a lead wire extending outwardly of the motor case, and is connected to the connector socket downward from above the connector socket;
a ceiling section of the motor case includes a projection that extends downward; and
a lower end of the projection is opposed in an axial direction to at least a portion of an upper surface of the connector plug.

2. The motor according to claim 1, wherein the lower end of the projection is located under the upper surface of the connector plug in a state where the connector socket and the connector plug are disconnected.

3. The motor according to claim 2, wherein
one of the connector socket and the connector plug includes:
a lever that is elastically deformable, and a protruded portion provided at a tip end of the lever; and
the other of the connector socket and the connector plug includes a recessed portion that houses the protruded portion in a state where connection between the connector socket and the connector plug is completed.

4. The motor according to claim 1, wherein the rotor is disposed outside the stator in the radial direction.

5. The motor according to claim 1, wherein the connector plug is disposed outside the rotor and the stator in the radial direction.

6. The motor according to claim 1, wherein the circuit board is disposed under the stator.

7. The motor according to claim 1, wherein
an inner bottom surface of the motor case includes a seat section that projects upward; and
a lower surface of the circuit board is in contact with an upper surface of the seat section.

8. The motor according to claim 7, wherein the seat section is disposed outside the projection in the radial direction.

9. The motor according to claim 7, wherein when viewed in the axial direction, at least a portion of the projection is disposed inside an area defined by connecting the central axis and both ends of the seat section in a circumferential direction.

10. The motor according to claim 9, wherein a length of the seat section in a direction perpendicular to the radial direction is longer than a length of the projection in the direction perpendicular to the radial direction.

11. The motor according to claim 1, wherein a radial distance between the central axis and the connector socket is longer than a radial distance between the central axis and an outer edge of the circuit board in a direction symmetric to the radial direction with respect to the central axis.

12. A driving device comprising:
the motor according to claim 1; and
a reducer that is connected to the motor to reduce speed of rotations of the motor and outputs resultant rotations.

13. The driving device according to claim 12, wherein
the motor includes a shaft to which the rotor is fixed and which is disposed along the central axis, and projects outwardly of the motor case; and
the reducer includes a gear fixed to the shaft.
